(19) United States
(12) Patent Application Publication
(10) Pub. No.: US 2016/0229126 A1
(43) Pub. Date: Aug. 11, 2016

(54) METHOD FOR DESIGNING SEAT CUSHIONS

(71) Applicant: Caterpillar Inc., Peoria, IL (US)

(72) Inventors: Joseph J. Every, Peoria, IL (US); Brittany A. Hancock, Chillicothe, IL (US); Aaron K. Amstutz, Peoria, IL (US); Ryan A. Lozier, Peoria, IL (US)

(73) Assignee: Caterpillar Inc., Peoria, IL (US)

(21) Appl. No.: 15/092,452

(22) Filed: Apr. 6, 2016

(51) Int. Cl. B29C 67/00; G01M 99/00; G01L 15/00; A47C 7/02; G01L 19/08

(52) U.S. Cl. CPC B29C 67/0088; A47C 7/022; G01L 19/086; G01L 15/00; G01M 99/001; B29C 67/0051; B29L 2031/58

(57) ABSTRACT

A method for manufacturing a seat cushion for a user is provided. The method comprises positioning the user on a test seat, scanning a plurality of pressure points of the user while the user is seated on the test seat, recording the plurality of pressure points to generate a pressure map, and manufacturing, using one of an additive manufacturing process, an additive manufactured tool and a molding process, the seat cushion conforming to the pressure map of the user.

### TECHNICAL FIELD

The present disclosure relates to seat cushions, and more specifically, to customized seat cushions designed as per ergonomics of a user.

### BACKGROUND

In general, seat cushions are attached with a seat (also called a chair) as an additional support to provide added comfort and support to an operator (also called a user). During day to day operations, the seat cushions closely accommodate and support the operator, and thereby provide comfort to the operator.

Currently, the operator suffers from fatigue and other occupational hazards that are caused by poor ergonomically fitted seat cushions. In most of the cases, the design of the seat cushions is unable to accommodate a variety of the operators. The seat cushions available today are designed as one size fits all. The seat cushions are not designed as per the ergonomics of the operator, and hence unable to offer a practical solution. Further, there are various machines that require different types of seat cushions that make the one size fits all option unworkable. Further, there is a need for a method for customizing seat cushions.

PCT Publication Number “WO2015171856” (hereinafter referred as '856) discloses a seat structure and a process for forming a frame. The seat structure includes at least one frame having one or more thin walled complex geometry structures. The thin walled complex geometry structures include one or more of multiple internal channels and ribs that defines a structure for supporting elements within the frame. The multiple channels and ribs defines one or more of structural loading paths and a channel for one or more of transporting fluids and receiving one or more components. Further, the process for forming the at least one frame via an additive manufacturing process is also disclosed. The '856 reference discloses the seat structure and the process for forming the frame. Therefore, there is a need for designing seat cushions according to the ergonomics of the user.

### SUMMARY OF THE DISCLOSURE

In one aspect of the present disclosure, a method for manufacturing a seat cushion for a user is provided. The method comprises positioning the user on a test seat, scanning a plurality of pressure points of the user while the user is seated on the test seat, recording the plurality of pressure points to generate a pressure map, and manufacturing, using one of an additive manufacturing process, an additive manufactured tool and a molding process, the seat cushion conforming to the pressure map of the user.

Other features and aspects of this disclosure will be apparent from the following description and the accompanying drawings.

### BRIEF DESCRIPTION OF THE DRAWING

FIG. 1 is a perspective view of a seat having seat cushions, in accordance with the concepts of the present disclosure;

FIG. 2 depicts a test seat for recording pressure points of a user, in accordance with the concepts of the present disclosure;

FIG. 3 is a side view of a test pad for recording the pressure points, in accordance with the concepts of the present disclosure;

FIG. 4 is a pressure map of the user, in accordance with the concepts of the present disclosure; and

FIG. 5 is a flowchart of a method for designing the seat cushions, in accordance with the concepts of the present disclosure.

### DETAILED DESCRIPTION

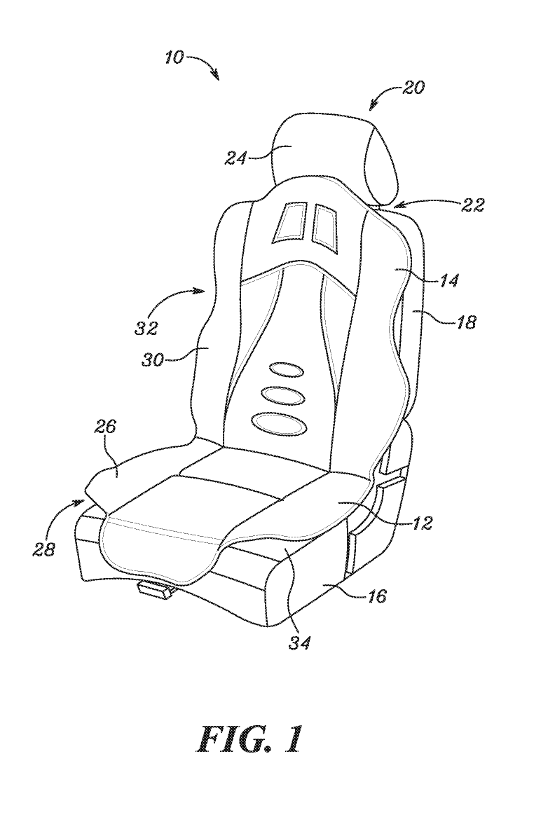

Referring to FIG. 1, a seat 10 having a first seat cushion 12, a second seat cushion 14, a base member 16, a back member 18, a head rest 20, a head rest joint 22 and a head rest cushion 24. In an embodiment, the seat 10 may be attached within a machine or vehicle (not shown) to carry out various operations. Alternatively, the seat 10 may also be attached in a stationary environment, such as an office, a control room to carry out various operations. It will be apparent to one skilled in the art that the seat 10 may be coupled at any other spot or location to carry out the operations, without departing from the meaning and scope of the disclosure.

Referring to FIG. 1, the first seat cushion 12 having a first surface 26 and a second surface 28. The second seat cushion 14 having a third surface 30 and a fourth surface 32. The second surface 28 of the first seat cushion 12 is positioned on a top surface 34 of the base member 16. Further, the fourth surface 32 of the second seat cushion 14 is positioned over the back member 18 of the seat 10. The first seat cushion 12, and the second seat cushion 14 having the first surface 26 and the third surface 30 respectively for supporting a body. It will be apparent to one skilled in the art that methods proposed herein may also be utilized for designing other articles, such as shoes, gloves, jackets, among others without departing from the meaning and scope of the disclosure.

Referring to FIG. 1, a height of the base member 16 of the seat 10 is adjusted by activation of a first lever (not shown) as per the requirements. The angle of the back member 18 with respect to the base member 16 is also adjustable by a second lever (not shown). Further, the height of the head rest 20 is also adjustable by use of a ratchet or similar mechanism (not shown). It will be apparent to one skilled in the art that the seat 10 may have any other design, shape and elements, such as hand rests, cup holders (not shown) without departing from the meaning and scope of the disclosure.

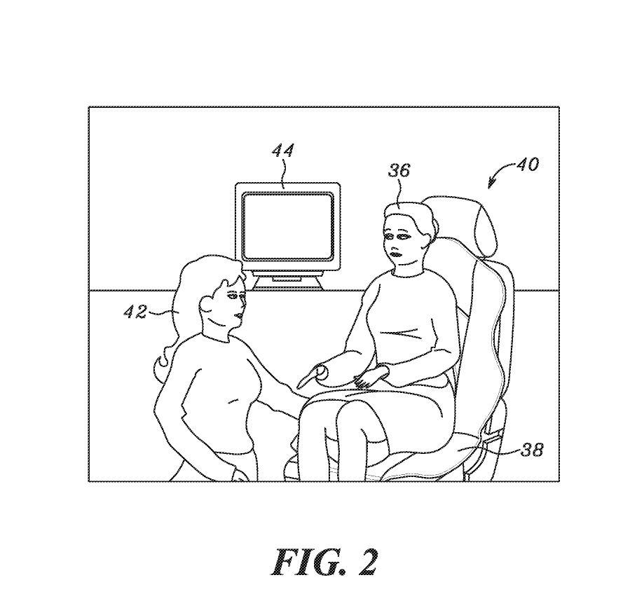

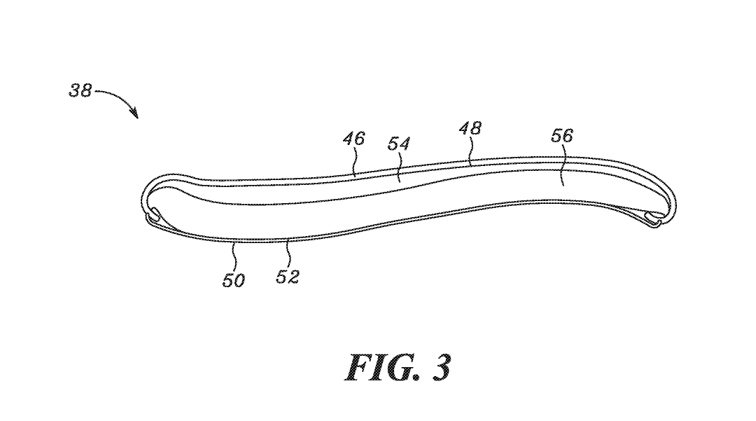

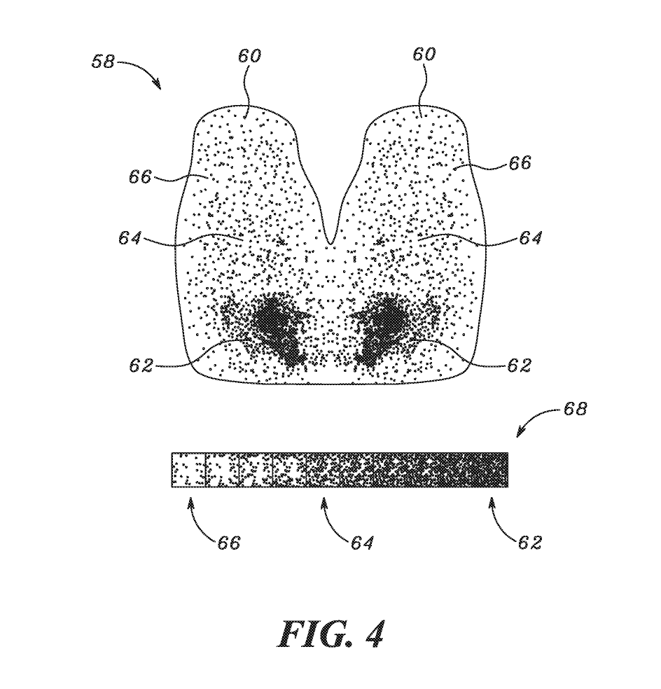

Referring to FIG. 2, a user 36 is seated on a test pad 38 (described below in FIG. 3) of a test seat 40. In an embodiment, the test seat 40 is placed in a test room for carrying out various procedures. In an embodiment, the teat pad 38 is a separate component that is coupled with the test seat 40. In another embodiment, the test pad 38 is inbuilt in the test seat 40. An instructor 42 checks posture of the user 36 and makes adjustments to the user 36 as per the requirements. The instructor 42 scans a number of pressure points, i.e. the pressure points 60 (as shown in FIG. 4) of the user 36, while the user 36 is seated on the test seat 40. A pressure map 58 (as shown in FIG. 4) is generated on the basis of the pressure points 60 and is displayed on a monitor 44.

Referring to FIG. 3, the test pad 38 having a textile layer 46, a foam layer 48, an outer shell 50, and an inner shell 52. The test pad 38 optionally uses a gel 54 spread over foam 56. It will be apparent to one skilled in the art that other materials, such as plastic, elastomers, fibers may also be used in place of a textile without departing from the meaning and scope of the disclosure. The test pad 38 utilizes a number of pressure sensors or pressure sensing devices (not shown) inside the test pad 38 that are configured to record and measure the pressure points 60 of the user 36 and generate the pressure map 58. It will be apparent to one skilled in the art that the test seat 40 may utilize various other types of pressure mapping system for recording the pressure points 60 of the user 36 without departing from the meaning and scope of the disclosure.

Referring to FIGS. 3 and 4, the pressure map 58 is generated from the pressure points 60 of the user 36. The pressure map 58 includes multiple pressure points 60 of the user 36 as generated by the pressure sensors (not shown) within the test pad 38. The pressure map 58 having regions for high pressure points 62, moderate pressure points 64, and low pressure points 66 as shown on a scale 68. The high pressure points 62 refer to points on the test pad 38 that bears a maximum pressure from the user 36, while the moderate pressure points 64 bears relatively lesser pressure on the test pad 38.

The pressure points 60 of the pressure map 58 are used to create a profile of the seat cushions, i.e. the first seat cushion 12, the second seat cushion 14 and the head rest cushion 24 specifically suiting the user 36. A software program develops a 3D cloud on the basis of the pressure map 58, which is then converted into a 3D model. A seat cushion profile is created using a 3D printing which is then fed into an additive manufacturing machine in which an object is created by laying down successive layers of materials. It will be apparent to one skilled in the art that the pressure map 58 is used for designing of the seat cushions, i.e. the first seat cushion 12, the second seat cushion 14 and the head rest cushion 24 using other techniques, not limited to, additive manufacturing processes and control software, such as 3D printing, scanning technologies known in the art without departing from the meaning and scope of the disclosure.

A designer uses a process in which the pressure map 58 is used to create a model for the seat cushions, i.e. the first seat cushion 12, the second seat cushion 14 and the head rest cushion 24 and this process is more manual. Further, additive manufacturing creates a tool/mold to create the seat cushions, i.e. the first seat cushion 12, the second seat cushion 14 and the head rest cushion 24. The materials used for additive manufacturing include, but are not limited to, different polymer types, metals, elastomers, and materials with varying density and hardness levels which are strategically placed or used in customizing the seat cushions, i.e. the first seat cushion 12, the second seat cushion 14 and the head rest cushion 24 to optimize user ergonomics. The pressure map 58 determines areas where high/moderate support is required and model a series of supporting structures (i.e. ribs, honeycomb) to provide support or flexibility where needed. There are also some 3D cloud programs that give the ability to add inputs as constraints to achieve specific design or functional requirements (i.e. loads, stresses).

The seat cushions, i.e. the first seat cushion 12, the second seat cushion 14 and the head rest cushion 24 are fabricated after analyzing the pressure map 58 of the user 36. Alternatively, the seat cushions, i.e. the first seat cushion 12, the second seat cushion 14 and the head rest cushion 24 are defined by having the user 36 sit on a mold material to get desired pressure patterns that are further processed. The seat cushions, i.e. the first seat cushion 12, the second seat cushion 14 and the head rest cushion 24 may be made from plastic, or foam, or a low hardness elastomeric material, The seat cushions, i.e. the first seat cushion 12, the second seat cushion 14 and the head rest cushion 24 may be manufactured from other processes or fabrication techniques, software other than described herein without departing from the meaning and scope of the disclosure.

It will be apparent to one skilled in the art that the measurements of the pressure map 58 may also be taken on a vehicle (not shown) during operation not necessarily in the test room. During vehicle operations, the test seat 40 and along with the test pad 38 are fitted in the vehicle and the pressure points 60 are scanned and saved in a storage device for further processing without departing from the meaning and scope of the disclosure. Further, the method for creating the pressure map 58 takes into account dynamic machine motion that is helpful in designing the seat cushions, i.e. the first seat cushion 12, the second seat cushion 14 and the head rest cushion 24. It is also possible to use a machine simulator to generate the dynamic machine motion.

### Industrial Applicability

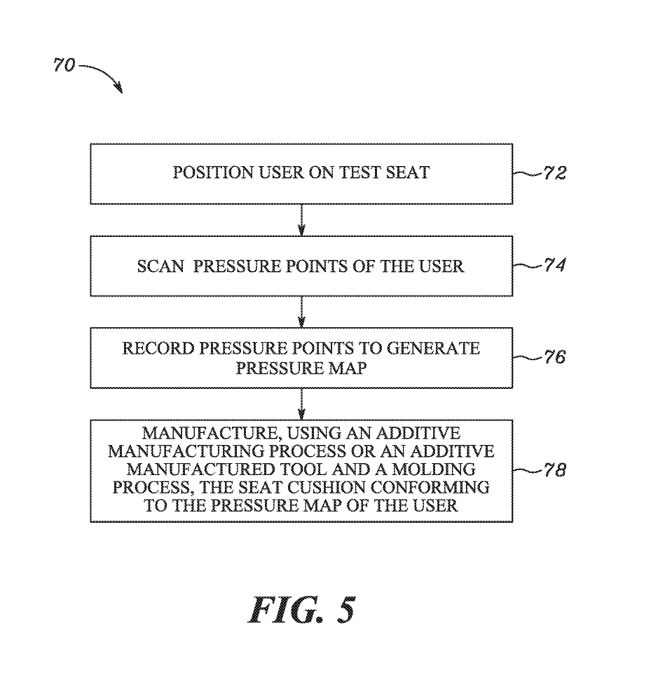

Referring to FIG. 5, a method 70 for designing the seat cushions, i.e. the first seat cushion 12, the second seat cushion 14 and the head rest cushion 24 is described in conjunction with the FIGS. 1-4.

At step 72, the user 36 is positioned on the test seat 40.

At step 74, the pressure points 60 of the user 36 are scanned.

At step 76, the pressure points 60 of the user 36 are recorded to generate the pressure map 58.

At step 78, the seat cushion, i.e. the first seat cushion 12, the second seat cushion 14 and the head rest cushion 24 are manufactured conforming to the pressure map 58 using an additive manufacturing process or an additive manufactured tool and a molding process.

Referring to FIGS. 1 and 2, customization of the seat cushions, i.e. the first seat cushion 12, the second seat cushion 14 and the head rest cushion 24 improve working efficiency of the user 36. The first seat cushion 12, the second seat cushion 14 and the head rest cushion 24 are customized according to a body shape and structure of the user 36. The first seat cushion 12, the second seat cushion 14 and the head rest cushion 24 are easy to retrofit over a variety of seats, i.e. the seat 10 as per user requirements. The first seat cushions 12, the second seat cushion 14 and the head rest cushion 24 are designed for ease of assembly to the seat 10 that make it easy for the user 36 to replace during a shift change.

Further, the method disclosed herein offers cost effective way for customizing the seat cushions, i.e. the first seat cushion 12, the second seat cushion 14 and the head rest cushion 24. Further, advancements in 3D printing and scanning technologies enables optimized seat cushion design and minimizes wastages.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for manufacturing a seat cushion for a user, the method comprising:
positioning the user on a test seat;
scanning a plurality of pressure points of the user while the user is seated on the test seat;
recording the plurality of pressure points to generate a pressure map; and
manufacturing, using one of an additive manufacturing process, an additive manufactured tool and a molding process, the seat cushion conforming to the pressure map of the user.
